(19) United States
(12) Patent Application Publication
(10) Pub. No.: US 2005/0071888 A1
(43) Pub. Date: Mar. 31, 2005

(54) Method and apparatus for analyzing subtitles in a video

(75) Inventors: Janice Marie Girouard, Austin, TX (US); Mark Joseph Hamzy, Round Rock, TX (US); Emily Jane Ratliff, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/674,975

(22) Filed: Sep. 30, 2003

(51) Int. Cl. H04N 7/16; H04N 9/74; H04N 7/08

(52) U.S. Cl. 725/136; 725/137; 348/589

(57) ABSTRACT

A method, apparatus, and computer instructions for processing video data. Text in the subtitles in the multimedia program data is identified to generate a set of text. The set of text is analyzed to form an analysis. A video segment that should be altered based on the analysis is identified to form an identified video segment and this identified segment is altered. Additionally, color corrections may be performed to enhance the visibility of text in subtitles.

### BACKGROUND OF THE INVENTION

1. Technical Field

The present invention relates generally to an improved data processing system and in particular to a method and apparatus for processing data. Still more particularly, the present invention relates to a method, apparatus, and computer instructions for processing video data.

2. Description of Related Art

Personal video recorders (PVRs) have become increasingly popular with consumers. These devices, also called digital video recorders (DVRs), allow a user to replay a recorded program while recording a new show. In some cases a live show may be watched on one channel, while another show is being recorded on a different channel. Also, a user may pause or replay scenes while watching a live show. Typically a PVR is connected to a cable or satellite system for receiving digital video and audio content. Like video cassette recorders, PVRs allow for time shifting of programs, but also allow for many additional features, such as recording all episodes of a show. These systems include a hard disk drive that is used to store programs.

PVRs also provide other features, such as an ability to share recorded programs with other PVRs over a network, store digital pictures, and store MP3 files. One feature missing from PVRs is an ability to filter out offensive content. In some cases, a user may desire to view a program, but have the offensive content filtered out of the program, such a feature is currently unavailable.

Therefore, it would be advantageous to have an improved method, apparatus, and computer instructions for managing programs on a PVR.

### SUMMARY OF THE INVENTION

The present invention provides a method, apparatus, and computer instructions for processing video data. Text in the subtitles in the multimedia program data is identified to generate a set of text. The set of text is analyzed to form an analysis. A video segment that should be altered based on the analysis is identified to form an identified video segment and this identified segment is altered. Additionally, color corrections may be performed to enhance the visibility of text in subtitles.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a data processing system in which the present invention may be implemented;

FIG. 2 is a flowchart of a process for filtering the multimedia program in accordance with a preferred embodiment of the present invention; and

FIG. 3 is a flowchart of a process for performing color corrections on subtitles in accordance with a preferred embodiment of the present invention.

### DETAILED DESCRIPTION OF THE PREFERRED EMBODIMENT

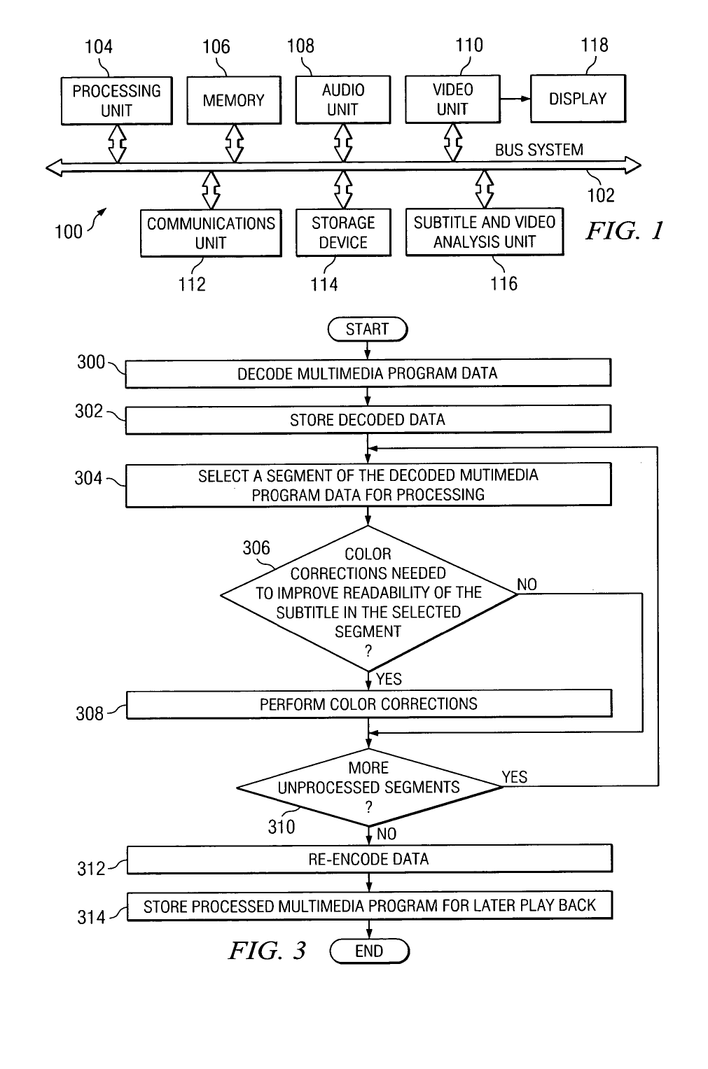

With reference now to the figures, and in particular with reference to FIG. 1, a diagram of a data processing system is depicted in which the present invention may be implemented. Data processing system 100 is an example of a personal video recorder (PVR), also referred to as a digital video recorder (DVR). As illustrated, the components within data processing system 100 are interconnected through bus system 102.

Data processing system 100 includes processing unit 104, memory 106, auto unit 108, video unit 110, communications unit 112, storage device 114, and subtitle and video analysis unit 116. Memory 106 contains instructions that may be executed by processing unit 104 to provide various PVR functions. These functions include, for example, recording a program, playing a program, analyzing video for processing, and managing programs that may be stored in data processing system 100.

Audio unit 108 contains components used to receive audio from an input and to output audio. These components may include, for example, an audio analog to digital converter (ADC), and an audio digital to analog converter (DAC). Video unit 110 is used to receive video and output video in data processing system 100. Video unit 110 may include, for example, an audio visual (AV) coder/decoder (codec). Video unit 110 may output video to be presented on a display device, such as display 118, connected to data processing system 100.

Depending on the particular implementation, components in audio unit 108 and video unit 110 may be implemented within processing unit 104 as hardware components. Communications unit 112 provides a connection for receiving multimedia programs. In this example, a multimedia program includes video and audio data. The multimedia program also may contain closed captioned data, such as subtitles. These subtitles may or may not be displayed depending on the user preference. Examples of multimedia programs include: television shows, movies, and music videos. These multimedia programs may be obtained by connecting communications unit 112 to programming various sources, such as over the Internet, through a cable network, or satellite.

Storage device 114 provides a location to store multimedia programs. Subtitle and video analysis unit 116 provides a mechanism to analyze text in the subtitles of multimedia programs and identify whether certain segments of these programs should be muted, blanked, or entirely deleted. In this manner, a user may view a multimedia program without portions of the program that may be objectionable to the user.

Subtitle and video analysis unit 116 may decode the video portion of the multimedia program for processing. Subtitle information is typically located in a separate channel from a video within a video stream. The subtitle information is overlaid onto the video in the frame buffer in a video adaptor or unit for presentation if the user desires to view the subtitles. This subtitle is also referred to as a close captioned portion of the video.

The text in the subtitles is identified. The text may be identified in different ways depending on the particular implementation. In the illustrative examples, optical character recognition may be performed on the closed captioned portion of the video dedicated to the subtitle output. The text from this process may be input into a filter to identify portions of the multimedia program that may be objectionable.

In these examples, the filtering is performed using a baysean filter, which may be implemented within subtitle and video analysis unit 116. Baysean filtering is currently used in filtering SPAM in email messages. This type of filtering may be applied to rating different portions of a multimedia program. With a baysean filter, a baysean inference may be employed that suggests if text in a subtitle is displayed during one scene or segment of the multimedia program appears often in a PG movie, but rarely appears in a G movie, that segment of the multimedia program the text is likely to be rated PG. If the preference is set for G rated multimedia programs, then the particular scene may be modified or censored. The video may be blank, the audio may be muted, or both muting and blanking may be performed on the segment.

In these examples, a segment of video is a portion of the video during which a subtitle is displayed. When a new subtitle is displayed, a new segment of the multimedia program is encountered.

The information used in filtering multimedia programs may be configurable by the user of data processing system 100. A default set of files may be established for various film ratings, such as G, PG, PG-13, and R. These default files may be stored in storage device 114. Further, a file provided by the user for use in baysean filtering also may be stored in storage device 114. This user file may come from various sources. For example, an email utility containing a baysean filtering feature may be used as a source. A file used for filtering SPAM email may be downloaded to data processing system 100. Of course, any external source may be used for this file.

Further, subtitle and video analysis unit 116 also may perform modifications to the video to improve the readability of subtitles. These modifications may include color correction to adjust the color in the portion of the screen in which the subtitles appear or adjust the display of the text of the subtitles. For example, the characters making up the text may be outlined with the color that is different from the background if the color of the text is similar to the color of the background. Additionally, the background color in the area in which the subtitles are displayed may be changed to provide a contrast for better readability of the subtitles.

In these examples, subtitle and video analysis unit 116 may be implemented in various forms. For example, this video unit may be implemented as a separate processing unit with appropriate application specific integrated circuits (ASICs) and instructions to perform the functions in the illustrative examples of the present invention. Alternatively, subtitle and video analysis unit 116 may contain instructions executed by processing unit 104 to provide these functions.

In these examples, data processing system 100 takes the form of a PVR. This illustration is not meant to be limiting with respect to the architecture in which the mechanism of the present invention may be implemented. Data processing system 100 also may be implemented using a computer with software and appropriate adaptor cards to allow for the reception and manipulation of multimedia programs using features found in a PVR.

In this manner, the mechanism of the present invention provides an ability to filter portions of a multimedia program. Even though a multimedia program may have an objectionable rating overall, the program may be viewed without the objectionable portions. Audio may be muted, video may be blanked, or both muting and blanking may be performed.

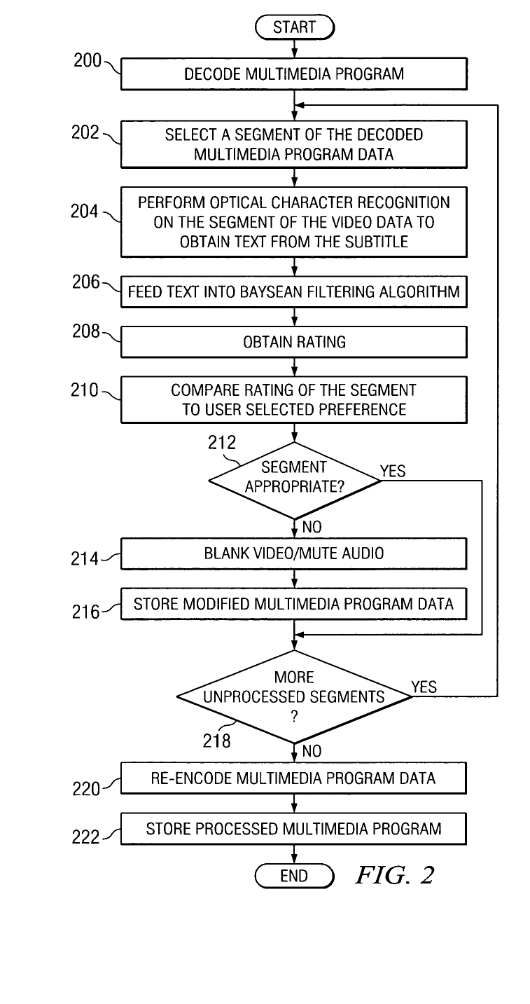

Turning now to FIG. 2, a flowchart of a process for filtering the multimedia program is depicted in accordance with a preferred embodiment of the present invention. The process illustrated in FIG. 2 may be implemented in a filtering system such as subtitle and video analysis unit 116 in FIG. 1.

The process begins by decoding of the multimedia program (step 200). In these examples, the video stream is received in a format, such as MPEG2, MPEG3, or JPEG. In these multimedia files, audio and video channels are separated into channels. The closed caption part containing the subtitles is in a separate channel from the video and audio. When desired, the closed caption portion may be overlaid on the video to present the subtitles.

The decoding of this data may be performed using a coder/decoder process in a component, such as a processing unit like processing unit 104 in FIG. 1. Coding and decoding may be implemented as described in the examples or in hardware, such as logic containing the coding and decoding functions, depending on the particular implementation.

A segment of the decoded multimedia program data is selected (step 202). In these illustrative examples, a segment of the data in the multimedia program data is defined as a number of frames. Video data is usually presented at thirty frames per segment.

Next, optical character recognition is performed on a segment of the multimedia program data to obtain text from the subtitle in the closed caption part of the data for that segment (step 204). This text is fed into a baysean and filtering algorithm (step 206). A rating is then obtained (step 208). The rating for this segment is compared to a user selected preference (step 210). This preference may be, for example, a film rating, such as PG-13 or R.

A determination is made as to whether the segment is appropriate with respect to the user selected preference (step 212). For example, if the user selects a rating of PG-13 as being appropriate, and the results of the filtering identify the text from the segment to be rated R, the segment would be identified as inappropriate. If the segment is inappropriate, some combination of the video and audio is blanked or muted (step 214). Although the processing is performed for a segment, step 214 actually blanks or mutes each of the frames in the segment. The modified multimedia program data is stored (step 216).

Next, a determination is made as to whether more unprocessed segments are present (step 218). If more unprocessed segments are present, the process returns to step 202. Otherwise, the multimedia program data is re-encoded (step 220), and the processed multimedia program is stored (step 222) with the process terminating thereafter.

In the example illustrated in FIG. 2, the processing occurs with respect to segments. Of course, depending on the particular implementation, the processing may occur on a frame by frame basis. Further, if coding and decoding is implemented in hardware, other functions, such as baysean filtering, and the frame buffer also may be located in the same hardware unit.

Turning next to FIG. 3, a flowchart of a process for performing color corrections on subtitles is depicted in accordance with a preferred embodiment of the present invention. The process illustrated in FIG. 3 may be implemented in a filtering system such as subtitle and video analysis unit 116 in FIG. 1.

The process begins by decoding the multimedia program data (step 300). In this example, the video portion of the multimedia program remains unchanged. The decoded data is stored (step 302). A segment of the decoded video data in the multimedia program is selected for processing (step 304). A determination is made as to whether this segment requires color corrections to improve the readability of the subtitle in the selected segment (step 306). Depending on the implementation, step 306 may determine if the text in the subtitle should be blocked out or made illegible. This step may be performed to block out bad or other offensive language. If corrections are needed the color corrections are performed (step 308). The particular type of color corrections performed may vary depending on the implementation. For example, the background for the text may be changed to increase the contrast for the text in the background. In another example, the text may be outlined with the color having a greater contrast with the background.

Then, a determination is made as to whether additional unprocessed segments are present in the video data (step 310). If additional unprocessed segments are present, the process returns to step 304. Otherwise, the data is re-encoded (step 312), and the processed multimedia program is stored for later playback (step 314) with the process terminating thereafter. With reference again to step 306, if color corrections are not needed, the process proceeds to step 310 as described above.

Thus, the present invention provides an improved method, apparatus, and computer instructions for filtering a multimedia program. The mechanism of the present invention in the illustrative examples allows for portions or segments of a multimedia program to be modified to meet user preferences while other portions remain unmodified. In the depicted example, these modifications include blanking a segment of the video, muting the audio for that segment, or blanking the video muting audio for the segment.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a data processing system for processing multimedia program data, the method comprising:
identifying text in the subtitles in the multimedia program data to generate a set of text;
analyzing the set of text to form an analysis;
identifying a portion of the multimedia program data that should be altered based on the analysis to form an identified portion; and
altering the identified portion

2. The method of claim 1, wherein the identifying step comprises:
performing optical character recognition on subtitles in the multimedia program data to generate the set of text

3. The method of claim 1, wherein the portion of the multimedia program data includes a video component and an audio component and wherein the identified portion is altered by blanking at least one of the video portion and the audio portion.

4. The method of claim 1, wherein the analyzing step includes:
performing baysean filtering on the set of text.

5. The method of claim 1 further comprising:
decoding the multimedia program data prior to initiating the performing step; and
re-encoding the multimedia program data after altering the identified portion.

6. The method of claim 1, wherein the portion of the multimedia program data is a frame or a group of frames.

7. The method of claim 1, wherein the multimedia program is a movie.

8. A method in a data processing system for processing a multimedia program, the method comprising:
decoding the multimedia program to form decoded multimedia program data;
analyzing a portion of the multimedia program data;
determining whether readability of a subtitle in the portion of the multimedia program data needs improvement; and
responsive to the readability of the subtitle in the portion of the multimedia program data needing improvement, performing color correction on a part of the multimedia program data containing the subtitle to improve readability of the subtitle.

9. A data processing system for processing multimedia program data, the data processing system comprising:
identifying means identifying text in the subtitles in the multimedia program data to generate a set of text; analyzing means for analyzing the set of text to form an analysis;
identifying means for identifying a portion of the multimedia program data that should be altered based on the analysis to form an identified portion; and
altering means for altering the identified portion.

10. The data processing system of claim 9, wherein the portion of the multimedia program data includes a video component and an audio component and wherein the identified portion is altered by blanking at least one of the video portion and the audio portion.

11. The data processing system of claim 9, wherein the analyzing step includes:
performing means for performing baysean filtering on the set of text.

12. The data processing system of claim 9 further comprising:
decoding means for decoding the multimedia program data prior to initiating the performing step; and
re-encoding means for re-encoding the multimedia program data after altering the identified portion.

13. The data processing system of claim 9, wherein the portion of the multimedia program data is a frame or a group of frames.

14. A data processing system for processing a multimedia program, the data processing system comprising:
decoding means for decoding the multimedia program to form decoded multimedia program data;
analyzing means for analyzing a portion of the multimedia program data;
determining means for determining whether readability of a subtitle in the portion of the multimedia program data needs improvement; and
performing means, responsive to the readability of the subtitle in the portion of the multimedia program data needing improvement, for performing color correction on a part of the multimedia program data containing the subtitle to improve readability of the subtitle.

15. A computer program product in a computer readable medium for processing multimedia program data, the computer program product comprising:
first instructions for identifying text in the subtitles in the multimedia program data to generate a set of text;
second instructions for analyzing the set of text to form an analysis;
third instructions for identifying a portion of the multimedia program data that should be altered based on the analysis to form an identified portion; and
fourth instructions for altering the identified portion.

16. The computer program product of claim 15, wherein the portion of the multimedia program data includes a video component and an audio component and wherein the identified portion is altered by blanking at least one of the video portion and the audio portion.

17. The computer program product of claim 15, wherein the second instructions includes:
sub instructions for performing baysean filtering on the set of text.

18. The computer program product of claim 15 further comprising:
fifth instructions for decoding the multimedia program data prior to initiating the performing step; and
sixth instructions for re-encoding the multimedia program data after altering the identified portion.

19. The computer program product of claim 15, wherein the portion of the multimedia program data is a frame or a group of frames.

20. A computer program product in a computer readable medium for processing a multimedia program, the computer program product comprising:
first instructions multimedia for decoding the multimedia program to form decoded program data;
second instructions for analyzing a portion of the multimedia program data;
third instructions for determining whether readability of a subtitle in the portion of the multimedia program data needs improvement; and
fourth instructions responsive to the readability of the subtitle in the portion of the multimedia program data needing improvement, for performing color correction on the part of the multimedia program data containing the subtitle to improve readability of the subtitle.

21. A data processing system comprising:
a bus system;
a communications unit connected to the bus system;
a memory connected to the bus system, wherein the memory includes a set of instructions; and
a processing unit connected to the bus system, wherein the processing unit executes the set of instructions to identifying text in the subtitles in the multimedia program data to generate a set of text; analyze the set of text to form an analysis; identify a portion of the multimedia program data that should be altered based on the analysis to form an identified portion; and alter the identified portion.

22. A data processing system comprising:
a bus system;
a communications unit connected to the bus system;
a memory connected to the bus system, wherein the memory includes a set of instructions; and
a processing unit connected to the bus system, wherein the processing unit executes the set of instructions to decode the multimedia program to form decoded multimedia program data; analyze a portion of the multimedia program data; determine whether readability of a subtitle in the portion of the multimedia program data needs improvement; and perform color correction on the part of the multimedia program data containing the subtitle to improve readability of the subtitle in response to the readability of the subtitle in the portion of the multimedia program data needing improvement.
